(19) United States
(12) Patent Application Publication
(10) Pub. No.: US 2017/0185961 A1
(43) Pub. Date: Jun. 29, 2017

(54) METHODS AND SYSTEMS FOR DETERMINING A DELIVERY ROUTE FOR A PHYSICAL PACKAGE HAVING AN ATTACHED IDENTITY MODULE

(71) Applicant: Intel Corporation, Santa Clara, CA (US)

(72) Inventors: Lital Shiryan, Ramat Gan (IL); Dor Levy, Jerusalem (IL)

(73) Assignee: Intel Corporation, Santa Clara, CA (US)

(21) Appl. No.: 14/757,895

(22) Filed: Dec. 24, 2015

(51) Int. Cl. G06Q 10/08; H04W 4/00; G06N 99/00; G06Q 10/10

(52) U.S. Cl. CPC G06Q 10/08355; G06Q 10/0833; G06Q 10/1097; G06Q 10/0838; H04W 4/008; G06N 99/005

(57) ABSTRACT

Technology for a system for generating a delivery option for a physical package is described. The system can include a memory device having instructions that, when executed by a processor, cause the system to receive package data from an identity module attached to the physical package intended for delivery to a package recipient. The package data can be analyzed to identify a package location of the physical package and the package recipient. Context data can be obtained for the package recipient that provides situational awareness of the package recipient and an expected agenda for the package recipient can be generated using the context data. At least one delivery option can be generated for the physical package based in part on the package location and the expected agenda for the package recipient, and the at least one delivery option can be provided to the package recipient.

### BACKGROUND

Electronic devices have become ever-present in many aspects of society. During the course of a normal day, a person may use a smart phone, a tablet device, and a laptop computer. Automobiles have also come to rely upon electronic systems to control and monitor many features and operations. Modern home appliances such as, for example, washers, dryers, and refrigerators may be driven and controlled by electronic systems. Manufacturing facilities, building heating and cooling systems and even farming equipment may now rely upon electronic sensors and control systems.

Advancements in communication technologies have allowed for even relatively simple electronic devices to communicate with systems over a computer network. For example, an electronic device in a manufacturing system may monitor various aspects of the manufacturing process and communicate monitoring data to a manufacturing system. Similarly, electronic sensors embedded in a building control system may monitor and communicate details regarding operation of the building's heating, cooling, and ventilation systems. Even home appliances offer the possibility of being configured with communication capabilities for purposes of transmitting status and receiving external controls.

### BRIEF DESCRIPTION OF THE DRAWINGS

Features and advantages of invention embodiments will be apparent from the detailed description which follows, taken in conjunction with the accompanying drawings, which together illustrate, by way of example, invention features; and, wherein:

FIG. 1 is a block diagram illustrating an example system and method for calculating a delivery route for a physical package to a delivery location in accordance with an example embodiment;

FIG. 2 is a block diagram that illustrates components of an example system environment used to calculate a delivery route for a physical package in accordance with an example embodiment;

FIG. 3 is a diagram illustrating an example system for shipping a physical package to a delivery location in accordance with an example embodiment;

FIG. 4 is a flow diagram that illustrates an example method for calculating a delivery route to a delivery location in accordance with an example embodiment;

FIG. 5 is a flow diagram illustrating an example method for generating delivery options for delivering a physical package to a package recipient in accordance with an example embodiment;

FIG. 6 is a diagram illustrating an example user interface used to provide delivery options to a package recipient in accordance with an example embodiment;

FIG. 7 is a diagram illustrating an example user interface used to provide a package recipient with shipping data for a physical package in accordance with an example embodiment;

FIG. 8 is a flow diagram illustrating an example method for calculating a delivery route to a delivery location for a physical package in accordance with an example embodiment;

FIG. 9 is a flow diagram illustrating an example method for generating delivery options for a physical package in accordance with an example embodiment; and

FIG. 10 is block diagram illustrating an example of a computing device that may be used to execute a method for calculating delivery routes and generating delivery options in accordance with an example embodiment.

Reference will now be made to the exemplary embodiments illustrated, and specific language will be used herein to describe the same. It will nevertheless be understood that no limitation on scope is thereby intended.

### DESCRIPTION OF EMBODIMENTS

Before the technology is described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various invention embodiments. One skilled in the relevant art will recognize, however, that such detailed embodiments do not limit the overall inventive concepts articulated herein, but are merely representative thereof.

As used in this specification and the appended claims, the singular forms “a,” “an” and “the” include plural referents unless the context clearly dictates otherwise. Thus, for example, reference to “a network” includes a plurality of such networks.

Reference throughout this specification to “an example” means that a particular feature, structure, or characteristic described in connection with the example is included in at least one invention embodiment. Thus, appearances of the phrases “an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

### Example Embodiments

An initial overview of technology embodiments is provided below and specific technology embodiments are then described in further detail. This initial summary is intended to aid readers in understanding the technology more quickly, but is not intended to identify key or essential technological features, nor is it intended to limit the scope of the claimed subject matter.

A technology is described for determining a delivery route to a delivery location using package data obtained from an identity module attached to, or contained within, a physical package and an expected agenda for a package recipient. A physical package may comprise any object that can be shipped from a beginning location to a destination location. For example, a physical package may comprise a letter, a parcel, or freight. A physical package can include an identity module attached to the physical package, contained within the physical package, or incorporated into the contents of the physical package. For example, an identity module can be attached to the exterior of a physical package using an adhesive, or the identity module can be packaged along with an item inside of a physical package. An identity module can be configured to store package related data, such as a package identifier and shipping information. Further, in some examples, an identity module can be configured with sensors that record package data that can be obtained from the identity module using an identity module reading device (e.g., a scanner), or the package data can be wirelessly transmitted over a network by the identity module. It should be noted that the identity module can be either active or passive. Active identity modules will typically require a power source. Passive identity modules, such as an RFID tag, typically do not require a power source.

A delivery route for a physical package may be a route from an origination shipping location, a shipping hub, or other intermediary location to a final delivery location. A delivery route, in one example, can be calculated using package data obtained from an identity module attached to the physical package, shipping information for the physical package obtained from a shipping system and an expected agenda for a package recipient. An expected agenda can be generated, in one example, using context data that provides a situational awareness of a package recipient. The expected agenda may include times and locations that a physical package can be delivered to the package recipient. A delivery location and time can be identified using the expected agenda and a delivery route for delivering the physical package to the delivery location can be calculated or determined based in part on the location of the physical package obtained from the identity module.

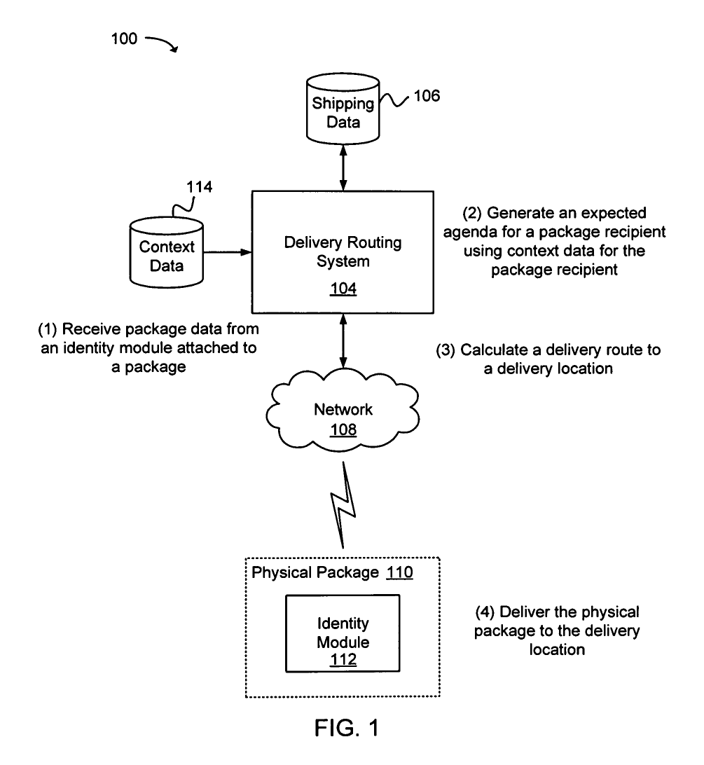

FIG. 1 is a diagram illustrating an example system 100 and method for calculating a delivery route for a physical package to a delivery location according to an expected agenda for a package recipient. As illustrated, the system 100 can include a delivery routing system 104 that receives package data from an identity module 112 attached to, or contained within, a physical package 110 via a network 108, and calculates a delivery route to a delivery location determined using the package data and an expected agenda for a package recipient.

An identity module 112, in one example, can be a device configured with a processor, memory, and sensors that record package data such as, location data, temperature data, humidity data, light data, pressure data, moisture data, radiation data, acceleration data, orientation data and/or nearly any other parameter or condition experienced by the package or its contents. The identity module 112 can include a power source, such as a battery. In some examples, the identity module 112 can include a radio used to wirelessly transmit package data to a receiver. In another example, an identity module 112 can be an electromagnetic readable device, such as a RFID (Radio Frequency Identification) device or a NFC (Near Field Communication) device. The identity module 112 can be configured to store information related to the physical package 110. In some examples, the electromagnetic readable device can be configured with writeable memory and one or more sensors that record package data to the writeable memory. Package data recorded to the writable memory can be read using an electromagnetic readable device (e.g., a RFID reader).

In one example, an identity module 112 may store a package identifier for the physical package 110. The package identifier can be used by the delivery routing system 104 to identify shipping data 106 for the physical package 110. Shipping data 106 can include shipper data, receiver data, content data, routing data, delivery location data, as well as other data. A package identifier for a physical package 110 and shipping data 106 for the physical package 110 can be provided by a package shipper. For example, a package shipper can scan an identity module 112 attached to a physical package 110 using a scanner to obtain a package identifier stored on the identity module 112 and submit the package identifier and shipping data 106 for the physical package 110 to the delivery routing system 104 for storage in the delivery routing system 104. Thereafter, during transit of the physical package 110, the package identifier can be obtained from the identity module 112 and the package identifier can be provided to the delivery routing system 104. Shipping data 106 for the physical package 110 stored in the delivery routing system 104 can be identified using the package identifier.

In another example, in addition to storing a package identifier, the identity module 112 can store shipping data for the physical package 110. For example, at the time of shipping, a package shipper can use an identity module programmer to write shipping data for a physical package 110 to an identity module 112. Thereafter, during transit of the physical package 110 to a delivery location, package data that includes the shipping information for the physical package 110 can be obtained from the identity module 112 using an identity module reader (e.g., a scanning device). In some examples, the identity module 112 can be configured with a wireless radio used to transmit package data that includes shipping data, as well as other information, to the delivery routing system 104.

A delivery route for a physical package 110, in one example, can be calculated either before or at the time the physical package 110 is shipped. The delivery routing system 104 can receive shipping data 106 for a physical package 110 that is to be shipped to a package recipient. In one example, the shipping data can include, or be determined, when the recipient confirms the delivery location. In this case, shipping route information can already be provided in the delivery routing system at the time a package shipper obtains the package for shipment. Alternatively, a package shipper may submit package data to the delivery routing system 104, whereupon a delivery route can be calculated. In addition, the In another example, a delivery route for a physical package 110 can be calculated at some point during transit of the physical package 110 to a package recipient. For example, after reaching a shipping hub, package data can be sent to the delivery routing system 104 and a delivery route to a package recipient can be calculated. Also, a delivery route can be updated or changed as a result of changes or updates made to an expected agenda for a recipient.

In calculating a delivery route for a physical package 110, context data 114 providing situational awareness of a package recipient can be obtained. In one example, context data 114 can be obtained from a calendar for a package recipient, a social networking account for the package recipient, an email account for the package recipient, as well as other context data sources providing situational awareness for the package recipient. Authorization to access context data 114 from various sources can be obtained from a package recipient. For example, a request authorizing access to context data 114 can be made to a package recipient. Also, a package recipient can manually submit context data 114 to the delivery routing system 104. For example, a package recipient can upload the package recipient's calendar to the delivery routing system 104.

An expected agenda for the package recipient can be generated using the package recipient's context data 114. The expected agenda can be a schedule of times and places that a package recipient is expected to be located. For example, a calendar for a package recipient can be used to generate an expected agenda for the package recipient. Generating an expected agenda can include calculating an estimated delivery window that a physical package 110 is expected to be delivered to the package recipient, and the expected agenda can be generated for a time that corresponds to the estimated delivery window. Further, in generating an expected agenda, delivery locations where a physical package 110 can be delivered to a package recipient may be identified. For example, a delivery location identified can be a house, a business location, a postal service, a pickup locker, or other delivery location associated with a package recipient.

In one example, a predictive model can be constructed and used to generate an expected agenda for a package recipient using context data 114 for the package recipient and a location history for the package recipient. For example, context data 114 and a location history for the package recipient can be obtained and an expected agenda can be generated using a machine learning model. Weights of probability can be applied to data representing times and places that a package recipient may be expected to be located based on the location history for the package recipient. For example, a statistical probability can be calculated for a package recipient keeping to an expected agenda. For instance, if the data shows that a package recipient cancels a specific calendar item 40%, 50%, or 60% of the time, then the calendar item may not be used as a delivery option because of the statistical probability that the package recipient may cancel the calendar item.

A location history used as part of generating an expected agenda can be a record containing times and places that a package recipient has been located in the past. Location data can be collected using, for example, a package recipient's GPS (Global Positioning System) enabled device, as well as other location history sources, such as social media accounts. Similar to obtaining context data 114 as described above, obtaining a location history for a package recipient can be performed according to authorization granted by a package recipient, or a package recipient can submit the package recipient's location history data to the delivery routing system 104.

After an expected agenda has been generated for a package recipient, one or more delivery locations and times for delivering a physical package 110 can be identified using in part the expected agenda. In one example, multiple delivery locations can be identified and the delivery locations can be evaluated to determine which delivery location(s) have the greatest chance of resulting in a successful delivery of a physical package 110. In one example, a delivery location that includes a delivery time, or multiple delivery locations and times can be presented to a package recipient. The package recipient can confirm the delivery location and time, or in the case of multiple delivery locations and times, the package recipient can select a delivery location and time from the multiple delivery locations and times. A package recipient can specify package delivery preference(s) that can be used in determining a delivery location and/or time. In another example, delivery locations and times can be ranked according to a statistical probability of success in delivering a physical package 110 to a package recipient at a particular location and time. A delivery location and time having the highest ranking can be selected and a delivery route to the location can be calculated.

Calculating a delivery route to a delivery location for a physical package 110 can, in one example, be performed by the delivery routing system 104 using shipping data 106 for the physical package 110 and a delivery location and time selected for the physical package 110. A current package location for the physical package 110 can be obtained from the shipping data 106 and a delivery route from the package location to the delivery location can be calculated. For example, a package location can be obtained from an identity module 112 attached to a physical package 110, or from shipping data 106 that can be updated when the identity module 112 is scanned at a location. The package location can be obtained and/or updated at various times during transit of the physical package 110.

After obtaining a package location for a physical package 110, a delivery route can be calculated that places the physical package 110 at a selected delivery location at a selected time. As an illustration, a physical package 110 shipped from overseas may arrive at a delivery hub ready for delivery to a local location. An identity module 112 attached to the physical package 110 can be scanned and shipping data 106 for the physical package can be updated, or the identity module 112 can be configured to communicate location data to the delivery routing system 104. The delivery routing system 104 can then use the location of the physical package 110 (the delivery hub) to calculate a delivery route to a selected delivery location at a selected time. Shipping data 106 for the physical package 110 can be updated with the delivery location and time, and a carrier for the physical package 110 can be notified in real time and provided with the delivery location and time.

In one example, a delivery route can be updated in response to conflicts with an expected agenda or changes made to a delivery location and time. For example, a delivery conflict associated with a delivery location for a physical package 110 can be identified using an updated expected agenda for the package recipient. In response to identifying the delivery conflict an alternate delivery location and time can be identified. In one example, a delivery conflict can be provided to the package recipient along with an alternate delivery location and time, and the package recipient can provide instructions to deliver the physical package to the alternate delivery location at the alternate time. As an illustration, a conflict in a package recipient's expected agenda may be identified (e.g., the package recipient may have cancelled all meetings for the day) and in response, the package recipient may be asked (e.g., via a push message) whether the package recipient would like the physical package 110 delivered to the package recipient's home. The package recipient can respond by indicating that the alternate delivery location is acceptable or not acceptable.

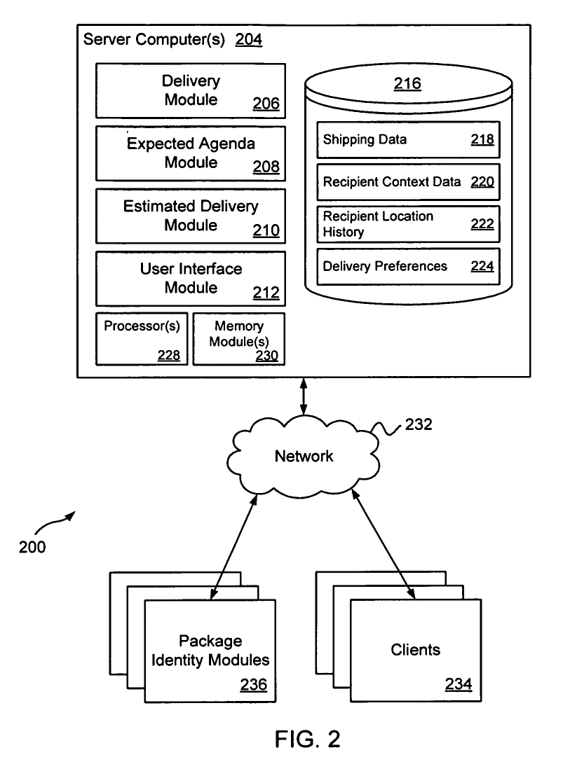

FIG. 2 illustrates components of an example system environment 200 on which the present technology can be executed. The system environment 200 can include a server computer 204 that can be in communication with package identity modules 236 (e.g., via intermediary systems) and clients 234 via a network 232. The server computer 204 can contain a number of modules used as part of a delivery routing service. In the example illustrated, the server computer 204 can include a delivery module 206, an expected agenda module 208, and estimated delivery module 210, a user interface module 212, as well as other modules.

The delivery module 206 can be configured to generate delivery options for delivering a physical package and calculate a delivery route for the physical package. A delivery option may be a time and location for delivering a physical package and a delivery route may specify a route from a package location (e.g., a shipping location, a shipping hub location, an in transit location, etc.) to a delivery location, and can additionally specify a delivery time for when a physical package is to be delivered to the delivery location. In generating a delivery option, a package location for a physical package can be determined and one or more potential delivery locations for delivering the physical package can be identified. A package location for a physical package can be determined using shipping data 218 associated with the physical package. Shipping data 218 can be provided by a package shipper, package recipient, or other entity, and may in part be provided by a package identity module 236 associated with a physical package. The shipping data 218 can be updated with location data for the physical package during transit of the physical package to a delivery location (e.g. in transit/in customs, etc.). For example, location data can be collected when a physical package is shipped from a shipping location, passes through a shipping hub, arrives at a package carrier, and any time while in route to a final delivery location.

The delivery module 206 may be configured to obtain an estimated delivery date for a physical package from the estimated delivery module 210. An estimated delivery date may be a date that a physical package may be ready for delivery to a package recipient. In another example, an estimated delivery window that the physical package may be delivered to the package recipient can be calculated. An estimated delivery date or window can be calculated using shipping data 218 for a physical package that includes information about the location of the physical package. Based on the location, an estimate for when the physical package may arrive at a package delivery facility can be calculated and returned to the delivery module 206.

After obtaining an estimated delivery date or window for a physical package, the delivery module 206 can be configured to identify one or more potential delivery locations for delivering the physical package on the estimated delivery data or within the estimated delivery window by obtaining an expected agenda from the expected agenda module 208 that coincides with the estimated delivery date. The expected agenda module 208 can be configured to obtain recipient context data 220 for a package recipient and generate an expected agenda using the recipient context data 220. In one example, a predictive model can be used to generate an expected agenda for a package recipient using recipient context data 220 for a package recipient and a recipient location history 222 for the package recipient as described earlier.

An expected agenda for a package recipient can be returned to the delivery module 206 and potential delivery locations can be identified using the expected agenda. More specifically, the expected agenda can include times and locations that a package recipient may be expected to be located. The times and locations can be evaluated to determine whether a physical package can be delivered to the package recipient. For example, locations that may be suitable for delivering a physical package can be identified (e.g., work, home, or postal office or external location according to context data such as out of office, meeting etc.), and times for delivering the physical package to the locations can be evaluated.

As a specific example, an expected agenda for a package recipient may indicate that the package recipient will be at school from 9 am-12 pm, at work from 1 pm-5 pm, at the gym from 5:30 pm-7 pm, and at home after 7:30 pm. Each location specified in the expected agenda can be evaluated to determine whether a physical package can be delivered during the time that the package recipient will be located at the location. Thus, for example, the locations work and home may be identified as viable delivery locations because they may be customary times and locations for delivering a physical package to an individual, whereas the locations school and gym may be identified as non-viable delivery locations because they may be non-customary times and/or locations for delivering a physical package to an individual. In some examples, a package recipient can specify delivery preferences 224 that include delivery location(s) and time(s) that can be used by the delivery module 206 to identify delivery locations and times for delivering a physical package to the package recipient. In other examples, delivery locations can be identified using in part the recipient context data 220 for the package recipient. For example, the recipient context data 220 can be analyzed to identify times and locations that a package recipient may frequent and then select a delivery location and delivery time from the identified times and locations.

After identifying one or more potential delivery times and locations for delivering a physical package to a package recipient, in one example, the delivery times and locations can be provided to the package recipient as delivery options. The package recipient can receive the delivery options via a user interface, push message, email, or other method, and the package recipient can select a preferred delivery option from the delivery options. The delivery module 206 can receive the delivery option selected by the package recipient and a delivery route to the delivery location can be calculated. The delivery option selected by a package recipient can be saved to shipping data 218 for a physical package, and/or delivery information for the delivery option can be written to a package identity module 236. In another example, the delivery module 206 can be configured to select a delivery time and location, via ranking or some other method, and calculate a delivery route to the delivery location.

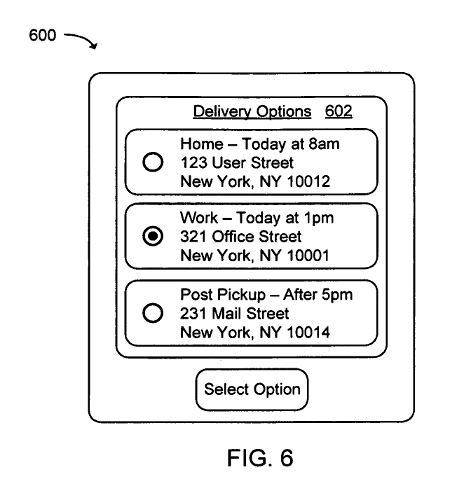

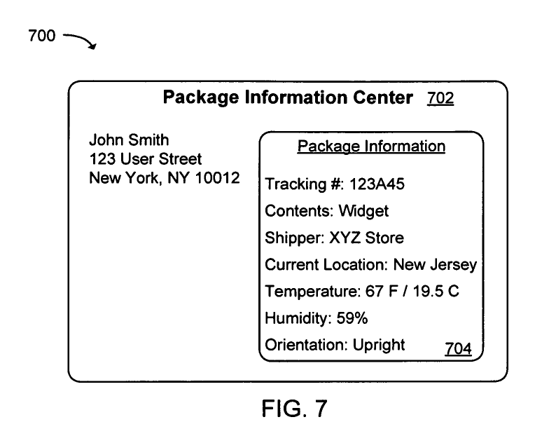

The user interface module 212 can be configured to execute a user interface that provides users (e.g., package shippers, package carriers, package recipients, etc.) access to the server computer 204 and data (e.g., shipping data 218) stored in a data store 216. Example user interfaces are shown in FIGS. 6 and 7. A user may utilize a client 234 to access the server computer via a user interface. A client 234 may include any device capable of sending and receiving data over a network 232. A client 234 may comprise, for example a processor-based system such as a computing device. A client 234 may be a device such as, but not limited to, a desktop computer, laptop or notebook computer, tablet computer, handheld computer, workstation, network computer, or other devices with like capability.

The various processes and/or other functionality contained within the system environment 200 may be executed on one or more processors 228 that are in communication with one or more memory modules 230. The system environment 200 may include a number of computing devices that are arranged, for example, in one or more server banks or computer banks or other arrangements. The computing devices may support a computing environment or computing service using hypervisors, virtual machine monitors (VMMs) and other virtualization software. The term “data store” can refer to any device or combination of devices capable of storing, accessing, organizing and/or retrieving data, which can include any combination and number of data servers, relational databases, object oriented databases, cluster storage systems, data storage devices, data warehouses, flat files and data storage configuration in any centralized, distributed, or clustered environment. The storage system components of the data store 216 can include storage systems such as a SAN (Storage Area Network), cloud storage network, volatile or non-volatile RAM, optical media, or hard-drive type media. The data store 216 can be representative of a plurality of data stores as can be appreciated.

The network 232 can include any useful computing network, including an intranet, the Internet, a local area network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 2 illustrates that certain processing modules may be discussed in connection with this technology and these processing modules may be implemented as computing services. In one example configuration, a module may be considered a service with one or more processes executing on a server or other computer hardware. Such services can be centrally hosted functionality or a service application that can receive requests and provide output to other services or consumer devices. For example, modules providing services may be considered on-demand computing that are hosted in a server, virtualized service environment, grid or cluster computing system. An API (Application Programming Interface) can be provided for each module to enable a second module to send requests to and receive output from the first module. Such APIs may also allow third parties to interface with the module and make requests and receive output from the modules. While FIG. 2 illustrates an example of a system that may implement the techniques above, many other similar or different environments are possible. The example environments discussed and illustrated above are merely representative and not limiting.

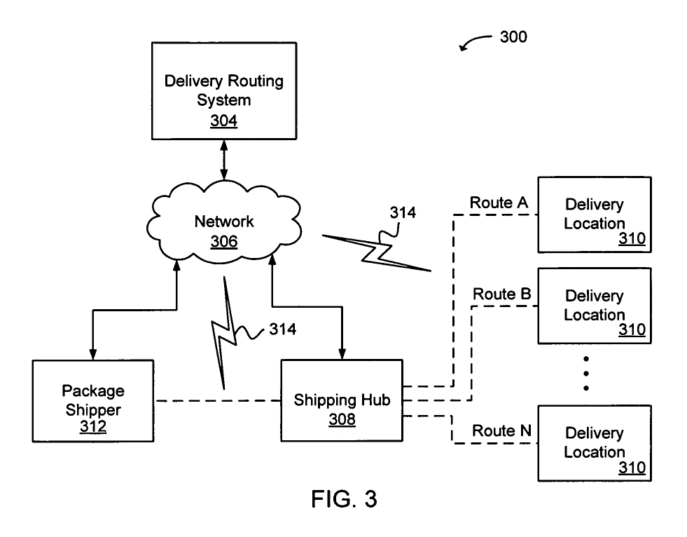

FIG. 3 is a diagram illustrating an example system 300 in which a physical package can be shipped from a package shipper 312 and delivered to a delivery location 310. As illustrated, a delivery routing system 304 can be in communication with a package shipper 312 and a shipping hub 308 via a network 306. In some examples, the delivery routing system 304 can be in communication with an identity module attached to, or contained within, a physical package via a wireless technology 314.

In one example, a package shipper 312 can submit shipping data for a physical package to the delivery routing system 304. The shipping data can include a location of the physical package being shipped as well as package recipient information. Using the shipping information and a package recipient's expected agenda, the delivery routing system 304 can be configured to identify delivery options for delivering the physical package to a delivery location 310. A delivery location 310 can be selected from the delivery options and the shipping data can be updated with the delivery location 310. In some examples, a delivery option can be generated based in part on a time of arrival of a physical package to a shipping hub 308. The time of arrival to the shipping hub 308 can be calculated using the location of the package shipper 312 and the location of the shipping hub 308.

In another example, a delivery location 310 can be determined when a physical package arrives at a shipping hub 308. For example, after arriving at a shipping hub 308, a physical package can be scanned using a scanner that transmits the package data to the delivery routing system 304. The delivery routing system 304 can identify delivery options for delivering the physical package to a delivery location 310 using shipping data for the physical package and an expected agenda for a package recipient.

During transit of the physical package to a delivery location 310, package data can be sent to the delivery routing system 304. For example, package data can be sent to the delivery routing system 304 during transit to a shipping hub 308, at the shipping hub 308, and to a delivery location 310. The package data can include location data for the physical package and other information, such as temperature data, humidity data, light data, acceleration data, orientation data, etc.

In one example, the transit data can be evaluated to determine whether a selected delivery location 310 may need to be updated. For example, based on a location of a physical package, a delivery location may be updated. As an example, according to a location of a physical package, an expected delivery date can be updated, which in turn may result in selecting a new delivery location 310. As an illustration, a delivery location 310 (e.g., route A) selected for delivery of a physical package can be based on a package recipient being in a first location (e.g., New York City on business). Due to a shipping error, an expected delivery date for the physical package can be recalculated, resulting in updating the delivery location 310 (e.g., route B) to a second location (e.g., the package recipient's home in New Jersey). Also, changes to a package recipient's expected agenda may result in updating a delivery location 310 to another delivery location 310. As will be appreciated, FIG. 3 illustrates one example of a system 300 that can be used to deliver a physical package to a delivery location. Many other systems can be used to deliver a physical package to a delivery location and these systems are included within the scope of this disclosure.

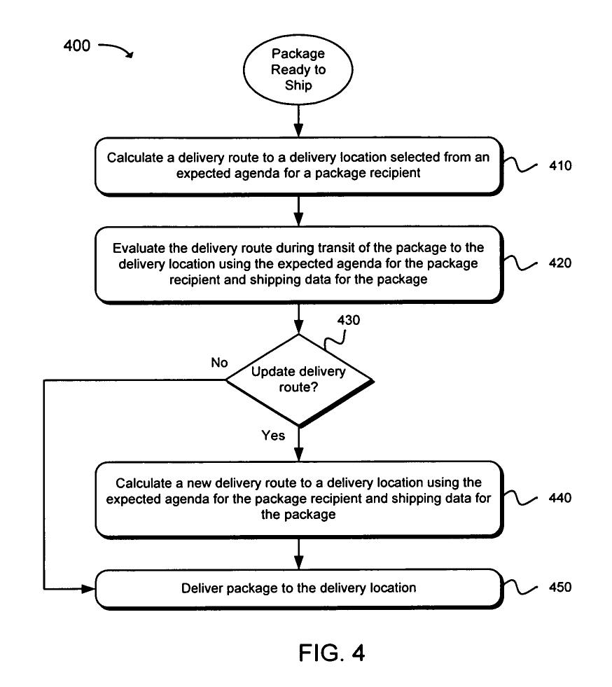

FIG. 4 is a flow diagram illustrating an example method 400 for calculating a delivery route to a delivery location. Starting in block 410, a delivery route to a delivery location selected from an expected agenda for a package recipient can be calculated for a physical package ready to be shipped to a package recipient. In one example, a shipper can submit shipping data for the physical package to a delivery routing system. The delivery routing system can be configured to generate an expected agenda using context data that provides situational awareness of the package recipient. A delivery route can then be calculated using the shipping data and the expected agenda for the package recipient. The delivery route may be from a shipper location to the delivery location.

As in block 420, the delivery route can be evaluated during transit of the physical package to the delivery location using the expected agenda for the package recipient and the shipping data for the physical package. For example, during transit of the physical package to the delivery location, the expected agenda for the package recipient can be periodically evaluated to determine whether the delivery location may need to be updated due to changes to the expected agenda. For example, should the package recipient cancel a meeting, or unexpectedly leave town, the package recipient's expected agenda can be revised and the delivery route can be evaluated to determine whether a new delivery location may need to be selected. Also, the shipping data for the physical package can be monitored to track the location of the physical package while in transit to the delivery location. In tracking the location of the physical package, an estimated arrival date of the physical package to the delivery location can be periodically evaluated to determine whether the estimated arrival date may need to be updated. In the event that the estimated arrival date is updated, the delivery location can be evaluated to determine whether a new delivery location may need to be selected.

As in block 430, in the case that the delivery route may need to be updated, then as in block 440, a new delivery route to a new delivery location and/or delivery time can be calculated using the expected agenda for the package recipient and shipping data for the physical package. As in block 450, the physical package can then be delivered to the delivery location. In the case that the delivery route is not updated, then the physical package can be delivered to the delivery location originally selected when the physical package was shipped from the shipper.

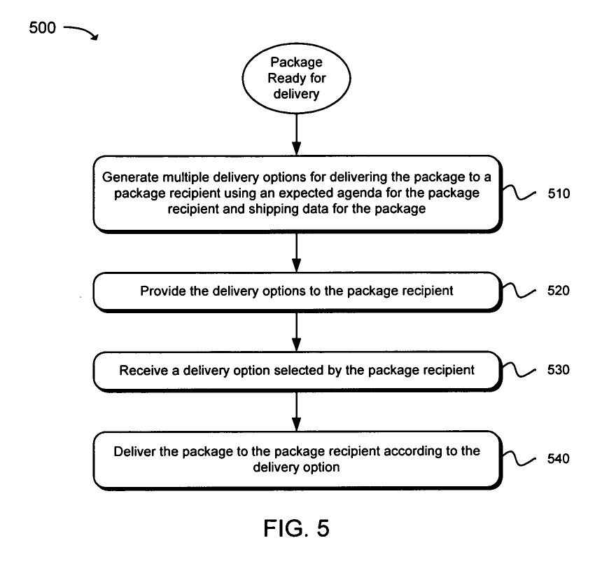

FIG. 5 is a flow diagram illustrating an example method 500 for generating delivery options for delivering a physical package to a package recipient. Beginning in block 510, multiple delivery options for delivering a physical package to a package recipient can be generated using an expected agenda for the package recipient and shipping data for the physical package as explained earlier. A delivery option may comprise a delivery location and a delivery time. In some examples, a delivery option can also comprise a delivery carrier. In addition to using the expected agenda and the shipping data, other information can be used to generate a delivery option.

In one example, a delivery option can be generated based in part on a time of arrival of the physical package to a shipping hub or other intermediary location. As an example, an estimated time of arrival to an intermediary location can be calculated and based on the estimated time of arrival, potential delivery locations and times can be identified that correspond with the estimated time of arrival. As another example, an estimated delivery window for when the physical package can be delivered to a package recipient can be calculated and delivery locations and times can be identified that correspond with the estimated delivery window.

In another example, a delivery option can be generated based in part on package content information for the physical package. Package content of a physical package may have an influence on which delivery locations may be selected. As an example, the package content of a physical package may be intended for a particular delivery location, such as a school, hospital, or event location. As such, a delivery location may be limited to the particular delivery location. As another example, the package content may limit the delivery locations to which the package can be delivered. For instance, the size and/or weight of the package content may limit potential delivery locations, or package content that is a hazardous material may limit potential delivery locations.

In yet another example, a delivery option can be generated based in part on a package carrier's availability to deliver the physical package. For example, a package carrier selected to deliver a physical package may not perform deliveries on certain days (e.g., Saturday or Sunday) and as a result, delivery options may be limited by the package carriers operating schedule.

After generating the delivery options, the delivery options can be provided to the package recipient, as in block 520. In one example, the delivery options can be presented to the package recipient via a user interface, push message, email, a notification associated with an app (i.e. application software) resident on a mobile device, or other method. As an illustration, a text message (e.g. an SMS text message) containing multiple delivery options for delivering a physical package can be sent to a package recipient asking the package recipient to select one of the multiple delivery options. In return, the package recipient can send back a text message containing the delivery option selected by the package recipient. In some examples, in responding to a delivery option request, a package recipient can specify additional information. For example, a package recipient can specify an alternate delivery location not included in the delivery options sent to the package recipient, or the package recipient can specify shipping information for an alternate recipient selected by the package recipient.

As in block 530, a delivery option selected by the package recipient can be received at a delivery routing system, and as in block 540, the physical package can then be delivered to the package recipient using the delivery option selected by the package recipient. In one example, a delivery location and a delivery time included in a delivery option can be sent to a package carrier associated with a delivery routing system and the package carrier can deliver the physical package to the delivery location at the delivery time. In another example, a package carrier available to deliver the physical package can be identified based in part on the delivery option selected by the package recipient. For example, the package recipient can specify that the package carrier be used, or a package carrier (e.g., a carrier company or contractor) available to deliver the package to the delivery location at the delivery time can be selected.

FIG. 6 is a diagram illustrating an example user interface 600 that can be used to provide a package recipient with delivery options 602 for delivering a physical package. As illustrated, multiple delivery options 602 can be provided to a package recipient using an electronic device. The delivery options 602 can include a description of a delivery location, an address of the delivery location, and a day and time when a physical package can be delivered to the delivery location. A package recipient can select one of the delivery options 602 and the selection can be transmitted to a delivery routing system configured to process the delivery option selected.

FIG. 7 is a diagram illustrating an example user interface 700 that can be used to provide a package recipient with shipping data for a physical package. The user interface 700 can be a package information center 702 used to display package data in a package information frame 704. The package data may in part be obtained from an identity module attached to, or contained within, a physical package. The package information frame 704 can be updated periodically. For example, an identity module can be configured to periodically transmit package data to a system and the package data displayed in the package information frame 704 can be updated with the package data received from the identity module. A package recipient can access the package information center 702 and monitor a physical package in transit to a delivery location via the package data shown in the package information frame 704.

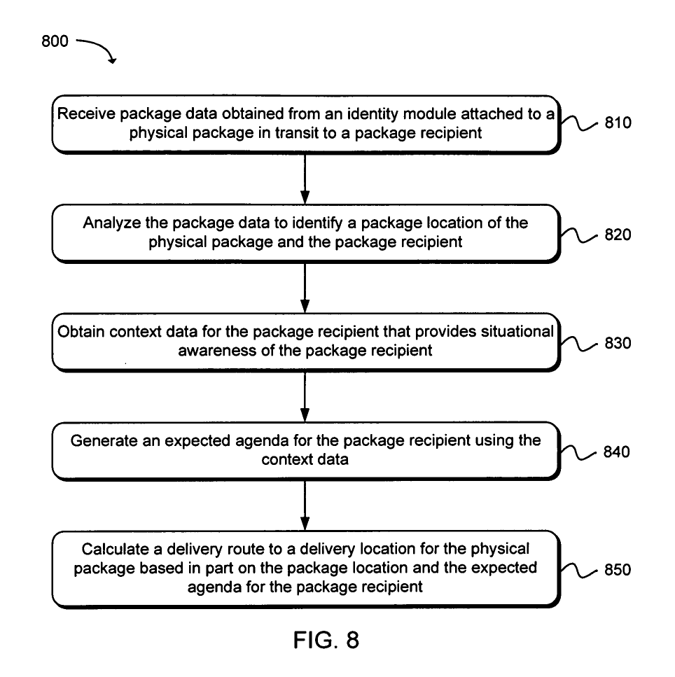

Another example provides a method 800 for calculating a delivery route to a delivery location for a physical package, as shown in the flow chart in FIG. 8. The method can be executed as instructions on a machine, where the instructions are included on at least one computer readable medium or one non-transitory machine readable storage medium. The method can include the operation of receiving package data obtained from an identity module attached to a physical package in transit to a package recipient, as in block 810. The method can include the operation of analyzing the package data to identify a package location of the physical package and the package recipient, as in block 820. The method can include the operation of obtaining context data for the package recipient that provides situational awareness of the package recipient, as in block 830. The method can include the operation of generating an expected agenda for the package recipient using the context data, as in block 840. The method can include the operation of calculating a delivery route to a delivery location for the physical package based in part on the package location and the expected agenda for the package recipient, as in block 850.

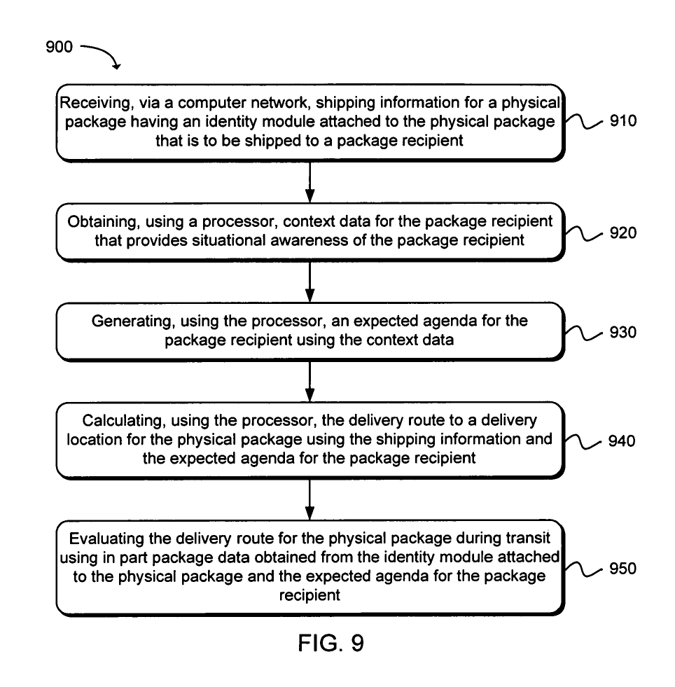

Another example provides a method 900 for generating delivery options for a physical package, as shown in the flow chart in FIG. 9. The method can be executed as instructions on a machine, where the instructions are included on at least one computer readable medium or one non-transitory machine readable storage medium. The method can include the operation of receiving, via a computer network, shipping information for a physical package having an identity module attached to the physical package that is to be shipped to a package recipient, as in block 910. The method can include the operation of obtaining, using a processor, context data for the package recipient that provides situational awareness of the package recipient, as in block 920. The method can include the operation of generating, using the processor, an expected agenda for the package recipient using the context data, as in block 930. The method can include the operation of calculating, using the processor, the delivery route to a delivery location for the physical package using the shipping information and the expected agenda for the package recipient, as in block 940. The method can include the operation of evaluating the delivery route for the physical package during transit using in part package data obtained from the identity module attached to the physical package and the expected agenda for the package recipient, as in block 950.

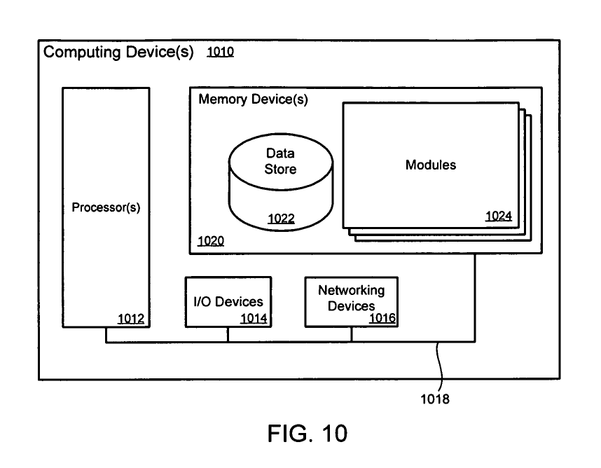

FIG. 10 illustrates a computing device 1010 on which modules of this technology may execute. A computing device 1010 is illustrated on which a high level example of the technology can be executed. The computing device 1010 can include one or more processors 1012 that are in communication with memory devices 1020. The computing device 1010 can include a local communication interface 1018 for the components in the computing device. For example, the local communication interface 1018 can be a local data bus and/or any related address or control busses as may be desired.

The memory device 1020 can contain modules 1024 that are executable by the processor(s) 1012 and data for the modules 1024. In one example, the memory device 1020 can include a delivery module, an expected agenda module, an estimated delivery module, a user interface module, and other modules. The modules 1024 can execute the functions described earlier. A data store 1022 can also be located in the memory device 1020 for storing data related to the modules 1024 and other applications along with an operating system that is executable by the processor(s) 1012.

Other applications can also be stored in the memory device 1020 and may be executable by the processor(s) 1012. Components or modules discussed in this description that can be implemented in the form of software using high programming level languages that are compiled, interpreted or executed using a hybrid of the methods.

The computing device can also have access to I/O (input/output) devices 1014 that are usable by the computing devices. Networking devices 1016 and similar communication devices can be included in the computing device. The networking devices 1016 can be wired or wireless networking devices that connect to the internet, a LAN, WAN, or other computing network.

The components or modules that are shown as being stored in the memory device 1020 can be executed by the processor(s) 1012. The term “executable” may mean a program file that is in a form that can be executed by a processor 1012. For example, a program in a higher level language can be compiled into machine code in a format that can be loaded into a random access portion of the memory device 1020 and executed by the processor 1012, or source code can be loaded by another executable program and interpreted to generate instructions in a random access portion of the memory to be executed by a processor. The executable program can be stored in any portion or component of the memory device 1020. For example, the memory device 1020 can be random access memory (RAM), read only memory (ROM), flash memory, a solid state drive, memory card, a hard drive, optical disk, floppy disk, magnetic tape, or any other memory components.

The processor 1012 can represent multiple processors and the memory device 1020 can represent multiple memory units that operate in parallel to the processing circuits. This may provide parallel processing channels for the processes and data in the system. The local interface 1018 can be used as a network to facilitate communication between any of the multiple processors and multiple memories. The local interface 1018 can use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described herein may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

### EXAMPLES

The following examples pertain to specific invention embodiments and point out specific features, elements, or steps that can be used or otherwise combined in achieving such embodiments.

In one example there is provided, a computer implemented method for calculating a delivery route, comprising:

receiving, via a computer network, shipping information for a physical package having an identity module attached to the physical package that is to be shipped to a package recipient;

obtaining, using a processor, context data for the package recipient that provides situational awareness of the package recipient;

generating, using the processor, an expected agenda for the package recipient using the context data;

calculating, using the processor, the delivery route to a delivery location for the physical package using the shipping information and the expected agenda for the package recipient; and

evaluating the delivery route for the physical package during transit using in part package data obtained from the identity module attached to the physical package and the expected agenda for the package recipient.

In one example of a method for calculating a delivery route, the method further comprises updating the delivery route in response to an updated expected agenda for the package recipient.

In one example of a method for calculating a delivery route, the context data for the package recipient further comprises a calendar for the package recipient and the expected agenda for the package recipient using the calendar.

In one example of a method for calculating a delivery route, generating the expected agenda for the package recipient using the context data further comprises generating a schedule comprising times and locations that the package recipient is expected to be located using the calendar for the package recipient.

In one example of a method for calculating a delivery route, generating the expected agenda for the package recipient using the context data further comprises obtaining a location history for the package recipient and generating the expected agenda using a machine learning model and the location history for the package recipient.

In one example of a method for calculating a delivery route, generating the expected agenda for the package recipient using the context data further comprises generating a schedule comprising times and locations that the package recipient is expected to be located using the context data and a calendar for the package recipient, and applying weights of probability to the times and locations that the package recipient is expected to be located based on a location history for the package recipient.

In one example of a method for calculating a delivery route, the method further comprises calculating an estimated delivery window that the physical package will be delivered to the package recipient.

In one example of a method for calculating a delivery route, generating the expected agenda for the package recipient further comprises generating the expected agenda for a time that corresponds to the estimated delivery window.

In one example of a method for calculating a delivery route, the method further comprises identifying multiple delivery locations and times for delivering the physical package using in part the expected agenda for the package recipient, and calculating the delivery route for a delivery location and time selected by the package recipient.

In one example of a method for calculating a delivery route, the method further comprises providing the multiple delivery locations and times to the package recipient, and receiving a delivery location and time selected by the package recipient.

In one example of a method for calculating a delivery route, providing the multiple delivery locations and times to the package recipient further comprises presenting the multiple delivery locations and times via a user interface, push message, or email.

In one example of a method for calculating a delivery route, the delivery location for the physical package is a house, business location, or postal service associated with the package recipient.

In one example of a method for calculating a delivery route, the method further comprises identifying a delivery conflict associated with the delivery location for the physical package using the expected agenda for the package recipient, and identifying an alternate delivery location.

In one example of a method for calculating a delivery route, the method further comprises providing the delivery conflict to the package recipient, providing the alternate delivery location to the package recipient, and receiving instructions to deliver the physical package to the alternate delivery location from the package recipient.

In one example of a method for calculating a delivery route, the package data for the physical package further comprises receiving sensor data generated by sensors included in the identity module.

In one example of a method for calculating a delivery route, the identity module has stored in a memory module recipient information and package content information.

In one example there is provided, system for generating a delivery option for a physical package comprising:

a processor;

a memory device including instructions that, when executed by the processor, cause the system to:
receive package data from an identity module attached to the physical package intended for delivery to a package recipient;
analyze the package data to identify a package location of the physical package and the package recipient;
obtain context data for the package recipient that provides situational awareness of the package recipient;
generate an expected agenda for the package recipient using the context data;
generate at least one delivery option for the physical package based in part on the package location and the expected agenda for the package recipient; and
provide the at least one delivery option to the package recipient.

In one example of a system for generating a delivery option for a physical package, the memory device includes instructions that, when executed by the processor, causes the system to further calculate a time of arrival of the physical package to a shipping hub using the package location, wherein the at least one delivery option is generated based in part on the time of arrival to the shipping hub.

In one example of a system for generating a delivery option for a physical package, the memory device includes instructions that, when executed by the processor, causes the system to further receive a delivery option selected by the package recipient from the at least one delivery option, and write delivery information for the delivery option to the identity module.

In one example of a system for generating a delivery option for a physical package, the memory device includes instructions that, when executed by the processor, causes the system to further receive shipping information for an alternate recipient selected by the package recipient.

In one example of a system for generating a delivery option for a physical package, the memory device includes instructions that, when executed by the processor, causes the system to further obtain package content information from the identity module, wherein the at least one delivery option for the physical package is generated based in part on the package content information.

In one example of a system for generating a delivery option for a physical package, the package data provided by the identity module attached to the physical package includes: location data, temperature data, humidity data, light data, acceleration data, or orientation data.

In one example of a system for generating a delivery option for a physical package, the memory device includes instructions that, when executed by the processor, causes the system to further execute a user interface showing the package data for the physical package.

In one example of a system for generating a delivery option for a physical package, the memory device includes instructions that, when executed by the processor, causes the system to further identify a package carrier that is available to deliver the physical package based in part on the delivery option selected by the package recipient.

In one example there is provided, a non-transitory machine readable storage medium having instructions embodied thereon for calculating a delivery route, the instructions when executed by a processor:

receive package data obtained from an identity module attached to a physical package in transit to a package recipient;

analyze the package data to identify a package location of the physical package and the package recipient;

obtain context data for the package recipient that provides situational awareness of the package recipient;

generate an expected agenda for the package recipient using the context data; and

calculate a delivery route to a delivery location for the physical package based in part on the package location and the expected agenda for the package recipient.

In one example of a non-transitory machine readable storage medium having instructions embodied thereon for calculating a delivery route, the expected agenda for the package recipient is generated for an expected delivery date of the physical package to the package recipient

In one example of a non-transitory machine readable storage medium having instructions embodied thereon for calculating a delivery route, further obtain approval for the delivery route from the package recipient.

In one example of a non-transitory machine readable storage medium having instructions embodied thereon for calculating a delivery route, further calculate multiple delivery routes for the physical package, provide the multiple delivery routes for the physical package to the package recipient, and receive a preferred delivery route selected from the multiple delivery routes by the package recipient.

In one example of a non-transitory machine readable storage medium having instructions embodied thereon for calculating a delivery route, further construct a predictive model used to generate the expected agenda for the package recipient using the context data for the package recipient and a location history for the package recipient.

In one example of a non-transitory machine readable storage medium having instructions embodied thereon for calculating a delivery route, further obtain a delivery preference for the package recipient, wherein the delivery route is calculated based in part on the delivery preference.

In one example of a non-transitory machine readable storage medium having instructions embodied thereon for calculating a delivery route, further identify delivery locations to deliver the physical package to the package recipient using in part the context data for the package recipient.

In one example of a non-transitory machine readable storage medium having instructions embodied thereon for calculating a delivery route, further identify delivery times to deliver the physical package to the package recipient using in part the context data for the package recipient.

In one example of a non-transitory machine readable storage medium having instructions embodied thereon for calculating a delivery route, further obtain the package data obtained from the identity module attached to the physical package using a scanner that transmits the package data to a computing service.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A computer implemented method for calculating a delivery route, comprising:
receiving, via a computer network, shipping information for a physical package having an identity module attached to the physical package that is to be shipped to a package recipient;
obtaining, using a processor, context data for the package recipient that provides situational awareness of the package recipient;
generating, using the processor, an expected agenda for the package recipient using the context data;
calculating, using the processor, the delivery route to a delivery location for the physical package using the shipping information and the expected agenda for the package recipient; and
evaluating the delivery route for the physical package during transit using in part package data obtained from the identity module attached to the physical package and the expected agenda for the package recipient.

2. A method as in claim 1, further comprising updating the delivery route in response to an updated expected agenda for the package recipient.

3. A method as in claim 1, wherein obtaining the context data for the package recipient that provides situational awareness of the package recipient further comprises obtaining a calendar for the package recipient and determining the expected agenda for the package recipient using the calendar.

4. A method as in claim 3, wherein generating the expected agenda for the package recipient using the context data further comprises generating a schedule comprising times and locations that the package recipient is expected to be located using the calendar for the package recipient.

5. A method as in claim 1, wherein generating the expected agenda for the package recipient using the context data further comprises obtaining a location history for the package recipient and generating the expected agenda using a machine learning model and the location history for the package recipient.

6. A method as in claim 1, wherein generating the expected agenda for the package recipient using the context data further comprises:
generating a schedule comprising times and locations that the package recipient is expected to be located using the context data and a calendar for the package recipient; and
applying weights of probability to the times and locations that the package recipient is expected to be located based on a location history for the package recipient.

7. A method as in claim 1, further comprising calculating an estimated delivery window that the physical package will be delivered to the package recipient.

8. A method as in claim 7, wherein generating the expected agenda for the package recipient further comprises generating the expected agenda for a time that corresponds to the estimated delivery window.

9. A method as in claim 1, further comprising:
identifying multiple delivery locations and times for delivering the physical package using in part the expected agenda for the package recipient; and
calculating the delivery route for a delivery location and time selected by the package recipient.

10. A method as in claim 9, further comprising:
providing the multiple delivery locations and times to the package recipient; and
receiving a delivery location and time selected by the package recipient.

11. A method as in claim 10, wherein providing the multiple delivery locations and times to the package recipient further comprises presenting the multiple delivery locations and times via a user interface, push message, or email.

12. A method as in claim 1, wherein the delivery location for the physical package is a house, business location, or postal service associated with the package recipient.

13. A method as in claim 1, further comprising:
identifying a delivery conflict associated with the delivery location for the physical package using the expected agenda for the package recipient; and
identifying an alternate delivery location.

14. A method as in claim 13, further comprising:
providing the delivery conflict to the package recipient;
providing the alternate delivery location to the package recipient; and
receiving instructions to deliver the physical package to the alternate delivery location from the package recipient.

15. A method as in claim 1, wherein the package data for the physical package further comprises receiving sensor data generated by sensors included in the identity module.

16. A method as in claim 1, wherein the identity module has stored in a memory module recipient information and package content information.

17. A system for generating a delivery option for a physical package comprising:
a processor;
a memory device including instructions that, when executed by the processor, cause the system to:
receive package data from an identity module attached to the physical package intended for delivery to a package recipient;
analyze the package data to identify a package location of the physical package and the package recipient;
obtain context data for the package recipient that provides situational awareness of the package recipient;
generate an expected agenda for the package recipient using the context data;
generate at least one delivery option for the physical package based in part on the package location and the expected agenda for the package recipient; and
provide the at least one delivery option to the package recipient.

18. A system as in claim 17, wherein the memory device includes instructions that, when executed by the processor, causes the system to further calculate a time of arrival of the physical package to a shipping hub using the package location, wherein the at least one delivery option is generated based in part on the time of arrival to the shipping hub.

19. A system as in claim 17, wherein the memory device includes instructions that, when executed by the processor, causes the system to further:
receive a delivery option selected by the package recipient from the at least one delivery option; and
write delivery information for the delivery option to the identity module.

20. A system as in claim 17, wherein the memory device includes instructions that, when executed by the processor, causes the system to further receive shipping information for an alternate recipient selected by the package recipient.

21. A system as in claim 17, wherein the memory device includes instructions that, when executed by the processor, causes the system to further obtain package content information from the identity module, wherein the at least one delivery option for the physical package is generated based in part on the package content information.

22. A system as in claim 17, wherein the package data provided by the identity module attached to the physical package includes: location data, temperature data, humidity data, light data, acceleration data, or orientation data.

23. A system as in claim 17, wherein the memory device includes instructions that, when executed by the processor, causes the system to further execute a user interface showing the package data for the physical package.

24. A system as in claim 17, wherein the memory device includes instructions that, when executed by the processor, causes the system to further identify a package carrier that is available to deliver the physical package based in part on the delivery option selected by the package recipient.

25. A non-transitory machine readable storage medium having instructions embodied thereon for calculating a delivery route, the instructions when executed by a processor:
receive package data obtained from an identity module attached to a physical package in transit to a package recipient;
analyze the package data to identify a package location of the physical package and the package recipient;
obtain context data for the package recipient that provides situational awareness of the package recipient;
generate an expected agenda for the package recipient using the context data; and
calculate a delivery route to a delivery location for the physical package based in part on the package location and the expected agenda for the package recipient.

26. A non-transitory machine readable storage medium as in claim 25, wherein the instructions that when executed by the processor further:
calculate multiple delivery routes for the physical package;
provide the multiple delivery routes for the physical package to the package recipient; and
receive a preferred delivery route selected from the multiple delivery routes by the package recipient.
